(19) United States
(12) Patent Application Publication
(10) Pub. No.: US 2003/0023330 A1
(43) Pub. Date: Jan. 30, 2003

(54) Memory expansion for form-factor constrained portable audio device

(75) Inventor: Clayton Neil Cowgill, Vancouver, WA (US)

Correspondence Address: Julie L. Reed, MARGER JOHNSON & McCOLLOM, P.C., 1030 S.W. Morrison Street, Portland, OR, 97205, US

(73) Assignee: SONICblue, Inc., Santa Clara, CA

(21) Appl. No.: 09/918,756

(22) Filed: Jul. 30, 2001

(51) Int. Cl. G06F 17/00; G10L 11/00

(52) U.S. Cl. 700/94; 704/272

(57) ABSTRACT

A portable audio device. The portable audio device includes a digital audio player that converts digital signals stored in a memory to audio signals and audio outputs that allow a user to hear the audio signals. The audio device also includes an expansion module residing separate from the player that provides extra capacity. The extra capacity may be memory or battery capacity. It may reside on a remote control or in the earphones, among other locations.

### BACKGROUND

1. Field

This disclosure relates to portable audio devices, more particularly to those with form factor constraints for portability and reduced weight.

2. Background

Portable audio devices include those designed to play music from removable media, such as tape and CD players. This class of devices also includes those designed to play music from solid-state memory, such as MP3 (Moving Pictures Experts Group, audio layer 3), and Windows Media player. The latter class of devices typically has upgrade capabilities so they can play new audio standards as they emerge and/or add additional storage space for content and are of the most interest here.

One appeal of these players is that they do not have the skipping problems associated with CD players, nor do they have the moving parts associated with either CD or tape players. Some manufacturers have targeted markets using larger devices with large memories. Other manufacturers have targeted markets desiring lightweight players with small form-factors.

The lightweight, small form-factor players have a disadvantage over the larger players in that they cannot hold as much audio data, storing fewer songs. This typically requires more downloads between the player and a computer to change songs and less playing time before songs are repeated. However, to add more memory would mean increasing form factors, an undesirable option for many users.

One possible solution has been the addition of expansion memory, in the form of small cards that can be inserted into the player. Examples include Multimedia Cards (MMC), SecureDigital (SD) cards, Compact Flash (CF), and Memory Sticks. However, the expansion slot on the player contributes to the player's bulk, and the addition of the card adds to its weight. Therefore, these expansion cards must get smaller to meet the desired weight and size restrictions.

To further complicate this solution, the current sizes of most of these cards have reached a point where users become concerned about losing them. As the cards get smaller, they are more expensive to manufacture, requiring higher retail prices. Consumers will hesitate to pay more money for such as small item that could be so easily lost. Therefore, adding an expansion slot on the player, while maintaining the desired size and weight, is often impractical.

Therefore, it would seem useful for there to be an alternative method to add memory to small, lightweight players without increasing the size or weight of the player itself.

### SUMMARY

The disclosure includes a portable audio device having a digital audio player that is capable of converting digital signals to audio signals, audio outputs that allow a user to hear the audio signals and an expansion module that extends the capability of the player and resides separately from the player. The expansion module may reside with the audio outputs and may comprise additional memory or an additional battery.

In one embodiment, the audio device includes a remote control that allows a user to operate the player separate from the player controls. The expansion module may then reside with the remote control. Also, the expansion module may be removable from the remote control.

### BRIEF DESCRIPTION OF THE DRAWINGS

The invention may be best understood by reading the disclosure with reference to the drawings, wherein:

FIG. 1 shows one embodiment of a portable audio device, in accordance with the invention.

FIG. 2 shows one embodiment of a remote control for a portable audio device, in accordance with the invention.

FIG. 3 shows one embodiment of audio outputs for a portable audio device, in accordance with the invention.

### DETAILED DESCRIPTION OF THE EMBODIMENTS

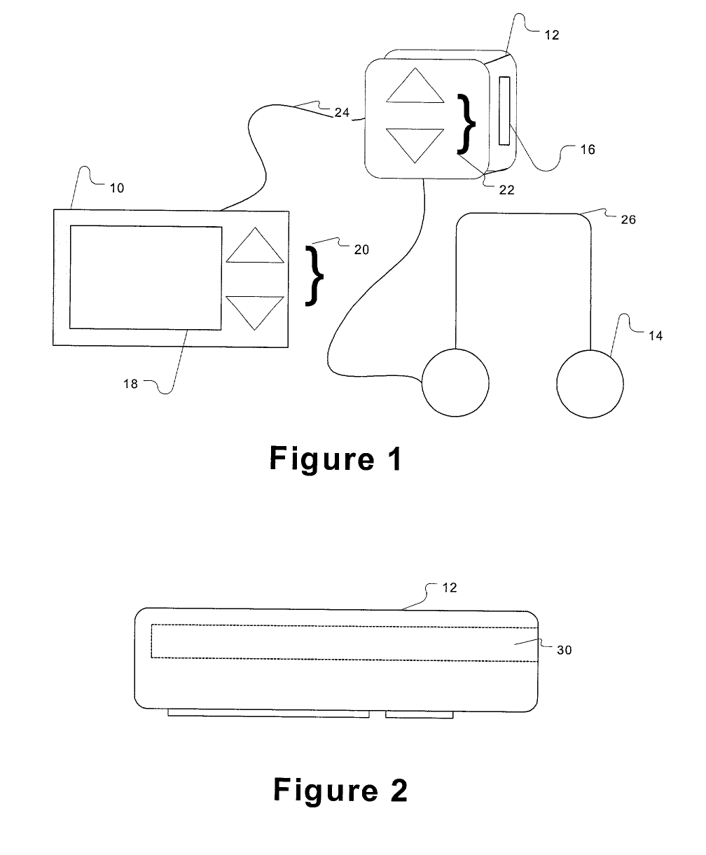

FIG. 1 shows a portable audio device. The device includes a digital audio player 10, a remote control 12 and earphones 14. The player 10 will typically include a display 18 to allow the user to view play lists, the current selection, etc., and control buttons 20 that allow the user to perform various control functions.

The player may play music of many different formats, including MP3 (Moving Picture Experts Group, audio layer 3), or Windows Media Audio® (WMA), among others. Digital audio players typically store the music as digital signals and have a processor or controller and associated logic circuitry to allow tracking and processing of the digital signals. Depending upon the format used to compress and store the digital signals, the processor or controller decompresses the files and an analog to digital converter typically then converts them into analog audio signals.

The user typically listens to the audio signals as they are being converted to sound by an audio output, such as a speaker. In the case of most portable digital audio devices, the audio outputs are earphones 14. However, small portable speakers may be used, or the audio device may be connected to a vehicle or home audio system. This allows the music to be played through the typically larger and more powerful vehicle speakers.

The remote control 12 is an optional accessory. It is not necessary to operate the player, but offers users a more convenient means to operate their players. Some portable audio devices are targeted for small form factors and have found a market with people who use their devices while engaged in physical activities such as jogging. It is typically more convenient to attach the player 10 to the body in locations that are better for movement, but make reaching the control buttons 20 inconvenient. The remote control 12 has another set of control buttons 22 that allow the user to operate the player without having to reach the buttons on the player.

One problem with the smaller form factor devices is the limitations on the amount of memory the player has. In some cases, players come with various sizes of memory cards that can be interchanged to allow more memory. However, even the largest capacity of these cards must fit into the small form factor of the device. Therefore, there is a limitation on how much capacity can reside on these cards when they are attached to or adjacent the player.

Application of the invention will allow the memory to reside separately from the player. ‘Separately’ as used here will refer to any location that is not adjacent to or in physical contact with the player. As examples, the memory could reside in the remote control 12 or in the earphones 14. These locations, and others, will be referred to as residing separately from the player.

In a first embodiment the memory could reside in the remote control 12, as shown in FIG. 1. Slot 16 would allow the user to insert additional memory into the remote. The player and the remote are shown as being connected by a wire or cable 24. This connection may also be wireless, but currently, most players use wired remotes. The connection allows the remote to provide extra capacity for the player. The extra capacity may be the form of memory, as discussed above, or in the form of power, such as an extra battery. The additional capacity will be provided in an expansion module.

If the extra capacity is memory, the memory could take several different forms. In the example of the remote 12 in FIG. 1, a slot 16 is provided for the expansion module. The slot could accept memory cards, flash memory or otherwise. Examples include MultiMedia Cards (MMC), Secure Digital cards™, or Memory Sticks™. These memory cards are available in a wide range of capacities, but generally are small and compact. However, similar to the players with insertable memory, the remote may have its own form factor constraints.

An alternative to insertable memory or batteries is having one as a part of the remote. This is shown in a top view in FIG. 2. The remote 12 has an expansion module 30 internally arranged. This is an integrated part of the remote, not a removable expansion module. The expansion module may be replaceable to allow a different module with higher capacity to be used. However, a replaceable module, as the term is used here, involves opening the remote case, removing the original module and replacing it with a new module. It is not removable through an expansion slot as it is the remote in FIG. 1.

Up to this point in the discussion, the expanded capacity separate from the player has focused on the remote. As mentioned above, the remote is an optional accessory for many portable audio devices and may not be available as a residence for the expansion module. Similarly, portable audio devices that include a remote control may not have the same configuration as the one in FIG. 1. The audio outputs may be connected directly to the player and the remote may be wireless. Due to movement and possible interference with the communications between a player and a wireless remote, it may not be desirable for the separate extra capacity to reside on the remote.

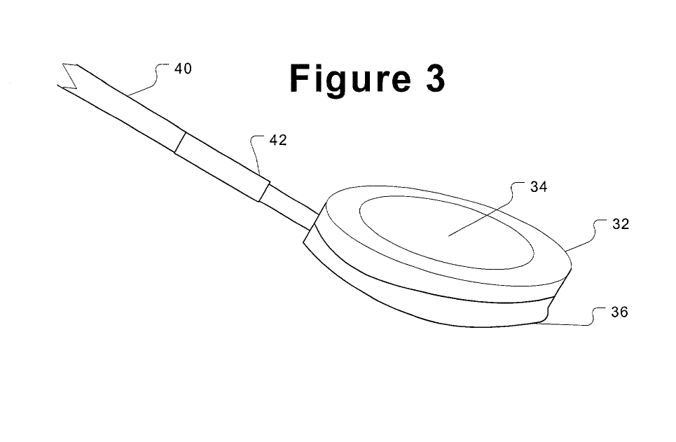

An alternative location for the expansion module could be the earphones or other audio output. Again, as mentioned above, most portable audio devices include earphones as the audio outputs. The expansion module could reside with the audio outputs, whether they are earphones or some other type of output component. An example of one earphone from the pair 14 from FIG. 1 is shown in FIG. 3.

The earphone 32 would have the speaker portion 34 that actually produces sounds from audio signals. This is the side of the earphone that would rest against the user's head. An expansion module 36 could also reside on the earphone. The expansion module would typically contain a battery or expansion memory. Earphones are configured in different ways, some having a cable running from both earphones to a juncture where those cables meet and then go to the player or the remote. Others may have one cable that runs into one of the earphones and then splits to also connect to the other earphone. In either case, an expansion module 36 could be resident on both earphones, or just one.

Similarly, some earphone sets come with a rigid plastic frame that positions the earphones on either side of the user's head. This is as opposed to the small ear ‘buds’ that users can insert directly into their ears. In the case of the frame, expansion memory could also reside in the earphone frame 40, such as a memory package 42. Both of these locations will be referred to as having the memory resident on the earphones. Typically, because of the form factor constraints and the much higher concern about weight with earphones, the expansion modules will not be removable, but may be replaceable as these terms are defined above.

As mentioned previously, the player portion of the portable digital audio device will have a processor or controller. The processor or controller will be responsible for locating and identifying any additional capacity. In one example, the processor or controller poll for any extensions and then perform a query and response process to identify if the expansion module is a memory or a battery.

Thus, although there has been described to this point a particular embodiment for a method and apparatus for expanded capacity in a form-factor constrained digital audio device, it is not intended that such specific references be considered as limitations upon the scope of this invention except in-so-far as set forth in the following claims.

What is claimed is:

1. A portable audio device, comprising:
a) a digital audio player operable to convert digital signals stored in a memory to audio signals;
b) audio outputs operable to allow a user to hear the audio signals; and
c) an expansion module operable to provide additional capacity to the digital audio player, wherein the expansion module resides at a location away from the digital audio player.

2. The portable audio device of claim 1, wherein the portable audio device further comprises a remote control connected to the player and the audio outputs.

3. The portable audio device of claim 1, wherein the expansion module resides on the remote control.

4. The portable audio device of claim 3, wherein the expansion modules is removable.

5. The portable audio device of claim 1, wherein the expansion module resides in the audio outputs.

6. The portable audio device of claim 1, wherein the expansion module contains additional memory.

7. The portable audio device of claim 1, wherein the expansion module contains a battery.

8. A portable audio device, comprising:
a) a digital audio player operable to convert digital signals to audio signals, the player comprising:
i) a memory operable to store digital signals;
ii) a battery operable to provide power; and
iii) a digital to analog converter operable to convert the digital signals to analog audio signals;
b) a remote control in connection with the player operable to allow a user to operate the player from the remote control;
c) an expansion module operable to provide additional capacity to the player, wherein the expansion module resides separate from the player; and
d) audio outputs operable to allow a user to hear the audio signals.

9. The portable audio device of claim 8, wherein the expansion module resides on the remote control.

10. The portable audio device of claim 9, wherein the expansion module is removable from the remote control.

11. The portable audio device of claim 9, wherein the expansion module resides in the audio outputs.

12. The portable audio device of claim 9, wherein the expansion module contains additional memory.

13. The portable audio device of claim 9, wherein the expansion module contains an additional battery.

14. A portable audio device, comprising:
a) a digital audio player operable to convert digital signals to audio signals, the player comprising:
i) a memory operable to store digital signals;
ii) a battery operable to provide power; and
iii) a digital to analog converter operable to convert the digital signals to analog audio signals;
b) a remote control in connection with the player operable to allow a user to operate the player from the remote control;
c) an expansion module resident on the remote control operable to provide additional capacity to the player, wherein the expansion module resides separate from the player; and
d) audio outputs operable to allow a user to hear the audio signals.

15. The portable audio device of claim 14, wherein the expansion module is removable from the remote control.

16. The portable audio device of claim 14, wherein the expansion module further comprises additional memory.

17. The portable audio device of claim 14, wherein the expansion module further comprises an additional battery.

18. A portable audio device, comprising:
a) means for converting digital signals stored in a memory to audio signals;
b) means for allowing a user to hear the audio signals; and
c) means for providing additional capacity to the digital audio player, wherein the expansion module resides at a location away from the digital audio player.

19. The portable audio device of claim 18, wherein the additional capacity is additional memory capacity.

20. The portable audio device of claim 18, wherein the additional capacity is additional battery capacity.
